(19) United States
(12) Patent Application Publication
(10) Pub. No.: US 2025/0137247 A1
(43) Pub. Date: May 1, 2025

(54) Wash Tunnel Arch

(71) Applicant: ABC Manufacturing, LLC dba ABC Wash Systems, Rochester Hills, MI (US)

(72) Inventor: Ismael Mosa-Basha, Rochester Hills, MI (US)

(21) Appl. No.: 18/932,704

(22) Filed: Oct. 31, 2024

Related U.S. Application Data
(60) Provisional application No. 63/594,484, filed on Oct. 31, 2023.

(51) Int. Cl. E04B 1/32; B60S 3/04

(52) U.S. Cl. CPC E04B 1/3205; B60S 3/04

(57) ABSTRACT

An arch support structure for a car wash system comprising the arch support structure comprising a plurality of members, the members including: two opposing vertical members, each including a top and a bottom portion; and one horizontal member disposed between and attached to the top portion of two opposing vertical members; wherein one or more of the plurality of members comprise: a housing profile that creates a first compartment and a second compartment; a hinged door assembly slidably attached to a first edge of the first compartment and a removable outer wall attached to opposing walls of the second compartment.

### CLAIM OF PRIORITY

This application claims the benefit of the filing date of U.S. Provisional Application No. 63/594,484, filed on Oct. 31, 2023. The contents of that application are incorporated by reference herein in their entirety and for all purposes.

### FIELD

The present teachings relate generally to an improved support structure for use in a vehicle wash tunnel. More specifically, the present teachings describe an improved support structure that has multiple chambers that allow various components to be housed within or attached to this structure, where a removable wall and door/hinge mechanism allows for easy access of these components.

### BACKGROUND

Providing an easily accessible and organized/concealed method of encapsulating various components that are used in a vehicle wash can lead to an aesthetically pleasing vehicle wash tunnel. It is well known in the prior art to have support structures (Arch Structures) of equipment in a tunnel wash system that have various components (e.g., plumbing, tubing, fans, motors, valves, etc.,) and wiring housed along or onto the Arch structures. It is also well known that these Arch structures can also house such components inside the structure itself, typically with limited access to an internal chamber of the Arch structure (e.g., via a hole or removable screwed-on panel). It is believed that it would be desirable to have a structure (Arch) that can contain various components used in a car wash tunnel in an aesthetically pleasing manner with the ability to service said components and/or swap in/out other components.

It would be desirable to improve the current state of the art by having an improved support structure according to these teachings.

### SUMMARY

An arch support system is disclosed herein, preferably for a car wash system. In a first aspect, the arch support structure for a car wash system can include: a plurality of members, the members including: two opposing vertical members, each including a top and a bottom portion; and one horizontal member disposed between and attached to the top portion of two opposing vertical members; wherein one or more of the plurality of members comprise: a housing profile that creates a first compartment and a second compartment; a hinged door assembly slidably attached to a first edge of the first compartment and a removable outer wall attached to opposing walls of the second compartment.

The teachings herein are further directed to: wherein the hinged door assembly comprises a male hinge portion integral to the first edge and a female hinge portion integral to a door profile, said male hinge portion slidably disposed within the female hinge portion and adapted to allow at least 80 degrees of rotation between each respective hinge portion; wherein the door profile mates to a ledge portion disposed at and created by a second edge of the first compartment; wherein each of the opposing walls of the second compartment includes a channel portion for receiving the removable outer wall portion therein; wherein the removable outer wall includes a plurality of protruding tabs adapted to compressively fit within the channel portion; wherein the removable outer wall is a translucent polymeric structure; wherein the one or more of the members is comprised of an aluminum extrusion; wherein the one or more of the members is comprised of a polymeric pultrusion; wherein there is two opposing angled members, each secured to one of the two opposing vertical members at the top portion and the one horizontal member which is disposed therebetween; and wherein the bottom portion of the vertical wall member is attached to an anchor member.

The first and second compartment may be substantially parallel to one another. The first and second compartment may be substantially co-extensive with one another. The first and second compartment may share a common wall. The first and second compartments may be substantially rectangular in shape. The first and second compartments may be integrally formed.

### BRIEF DESCRIPTION OF THE DRAWINGS

FIG. 1 is a perspective view of an illustrative car wash system.

FIG. 2 is a perspective view of an illustrative arch support structure according to the present teachings.

FIGS. 3 & 4 are top sectional view of the housing with an illustrative hinged door according to the present teachings.

FIG. 5 is a top sectional view of the housing with an exemplary channel with an illustrative removable outer wall.

FIG. 6 is a top sectional view of the illustrative removable outer wall of FIG. 5.

FIG. 7 is top sectional view of the housing with a detailed section of the male hinge portion.

FIG. 8 is top sectional view of the hinged door assembly with a detailed section of the female hinge portion.

FIGS. 9 and 10 are top sectional views of the housing with another exemplary channel and another illustrative removable outer wall.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The teachings herein provide for an arch structure that has the dual function of not only protecting the various devices located within the arch, but also allowing for simplified access to the devices for modifying, adjusting, repairing or replacing the devices within the arch structure. Devices typically utilized in a car wash that may be connected to an arch include sprayers, foamers, lights, pumps, valves, tubes, brushes, dispensers, and other devices that assist in washing, waxing, and protecting vehicles. A number of these devices may be connected to the exterior of the arch. While this arrangement facilitates ease of removing the devices, it provides no protection and exposes the devices to powerful water sprays, cleaning chemicals, waxes, and other materials that can cause corrosion and other types of degradation over time. In the event that an arch contains the different devices inside the arch, they are difficult to access and require both tools and time, which will also lead to downtime for the car wash to simply change out a device. The arches described herein include a simplified means to access car wash-related devices while still providing secure protection from the elements in the car wash setting.

The arches described herein include one or more members, compartments, doors, and hinges for maintaining a closed, yet accessible space within the arch. The arch may have one or more access points to access the compartments (e.g., each compartment may have one or more access points). The access points may be a hinged door or a sliding structure. The structure of the access point of one compartment may differ from the structure of the access point of another compartment.

The compartments may include one or more walls. The shape of each compartment may be the same, or may differ. The shape of the compartments may be substantially rectangular. The shape of the compartments may be substantially rounded. The shape of the compartments may be substantially triangular.

The one or more walls of the compartments may include one or more features for facilitating engagement of the walls with structures to close off the compartments. For example the one or more walls may include a hinge. The one or more walls may include a channel for receiving a portion of a wall or door. The one or more walls may include one or more projections for engaging with a receiving feature on another wall or door. The one or more walls may include structures for facilitating a snap-fit or friction fit engagement between a wall and another wall or door. The features on the one or more walls may allow for engagements between walls and/or doors that are sufficiently secure to avoid substantial entry of water, cleansers, waxes or other materials into the compartments. Thus the features may engage with adjacent features in a manner that minimizes space in the connection between the walls and/or doors.

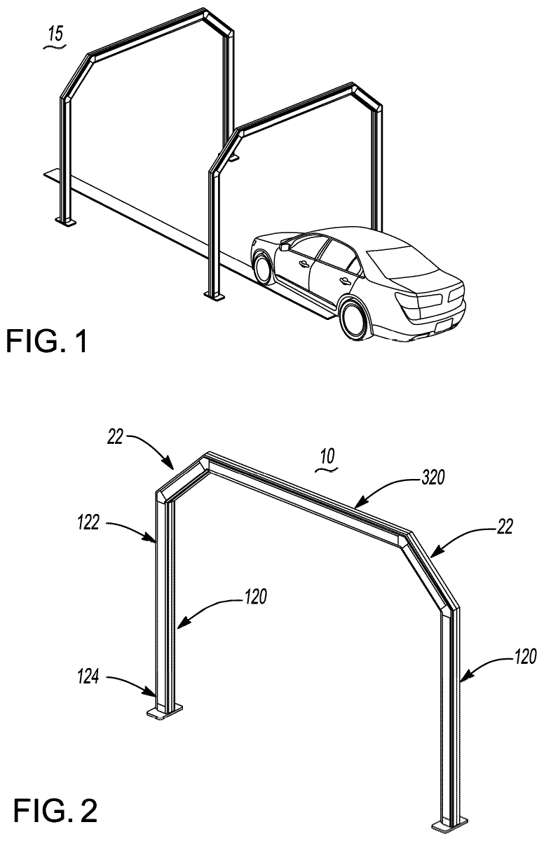

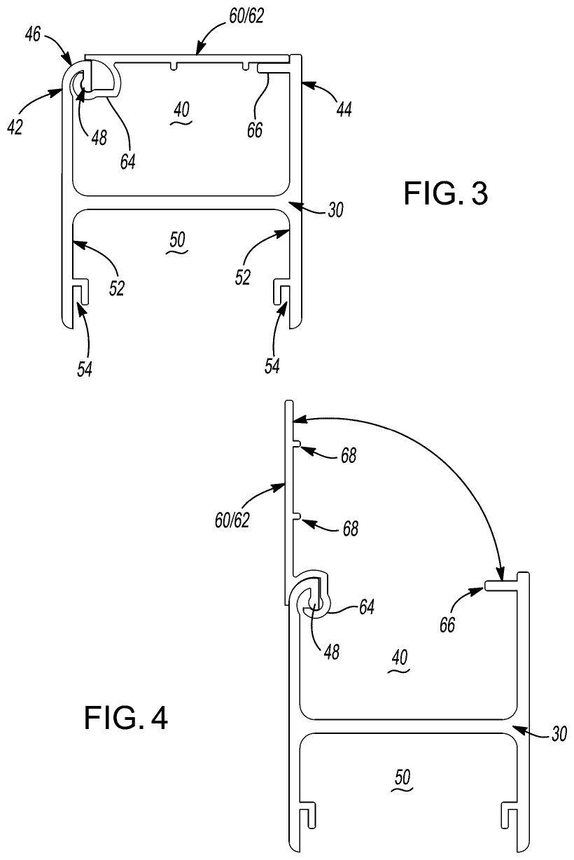

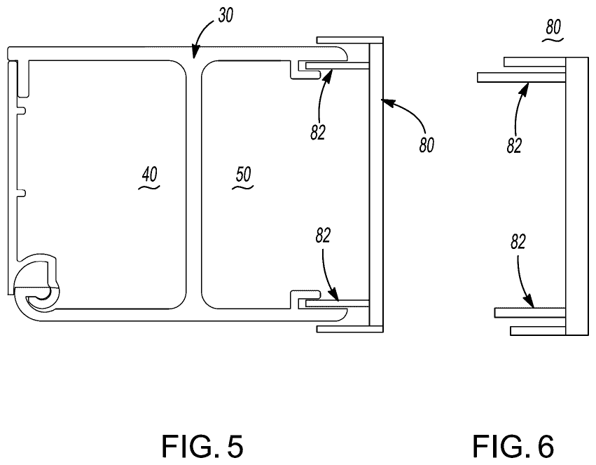

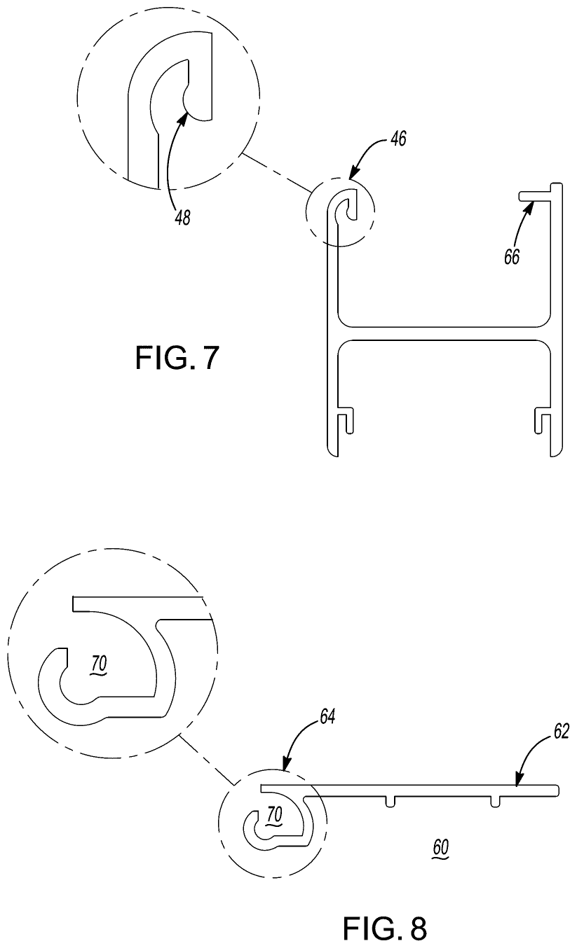

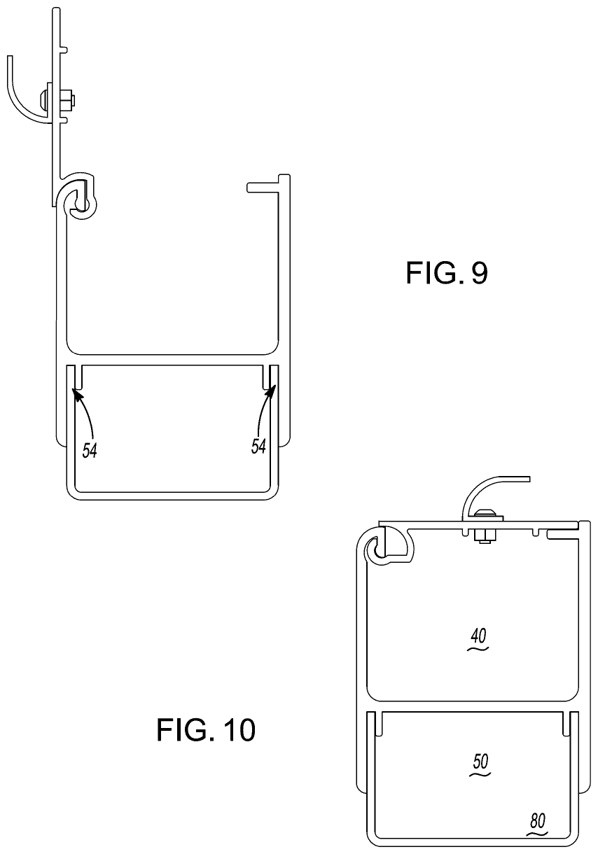

FIGS. 1 through 10 illustrate the inventive arch support structure 10 and its various components. It is contemplated that the arch 10 is utilized as part of a car wash system 15 where the arch 10 can house various components such as plumbing and lighting. Each of the major components of the arch 10 are discussed in further detail below.

Typically, car wash system 15 provides a tunnel in which soap, water, wax, polish and the like are applied to a car in various steps. It is contemplated that these may be applied via various plumbing lines which may be advantageously disposed within the arch 10 of the present teachings.

It is contemplated that the arch 10 consists of a plurality of members 20, which may include vertical, angled, and horizontal members (120/22/320). Each vertical member may include a top portion 122 and bottom portion 124. These members and/or portions may have the same or very similar geometric characteristics, such as having identical housing profile 30 and having hinged door assemblies 60 or may be dissimilar to each other. In one embodiment, the housing profile 30 for each member is the same.

It is contemplated that the housing profile 30 creates one or more compartments. The housing profile may include exactly two compartments (40/50). The housing profile may include exactly three, exactly four, exactly five, or exactly six compartments. The housing profile may include at least two compartments. It is contemplated that a first compartment may be closed off by a hinged door assembly 60. The second compartment 50 may be closed off by a removable outer wall 80. The first compartment 40 may include one or more walls with a first edge 42 and a second edge 44. A hinged door assembly 60 may be attached (may be slidably attached) to the first edge 42 of the first compartment 40. A removable outer wall 80 may be attached to opposing walls 52 of the second compartment 50. The first edge 42 of the first compartment 40 may include a male hinge portion 46 integrally formed therein. The second edge 44 may include a ledge portion 66—the ledge portion 66 adapted to nest with an edge of the door profile 62. In a preferred embodiment, the second compartment 50 includes opposing walls 52 and a channel portion 54. The channel portion 54 is adapted to receive the removable outer wall 80, or at least to receive one or more tabs 82 that may project from the outer wall 80.

It is contemplated that the members (120/220/320), the door assembly 60, the removable outer wall 80, or any combination thereof may be constructed of any number of materials, such as metals, polymers, or a combination thereof. In one embodiment, the members and door are mainly constructed of an extruded aluminum or a pultruded polymer. The removable outer wall may be translucent or transparent. The members may be formed of a single material or may be formed of multiple materials. Any aspects of the members shown as integrally formed may also be constructed of multiple separate parts that are connected by a fastening means which may be a mechanical fastener or adhesive.

It is further contemplated that one or more of the members include a hinged door assembly 60. It may include a door profile 62 that has a separate hinge attached thereto (e.g., a piano hinge) or may include an integrally formed hinge portion (e.g., a male and/or female hinge portion 46/64). In one embodiment, the female hinge portion 64 is formed as part of the door profile 62 and adapted to mate with its corresponding male hinge portion 46 that is formed as part of the first edge 42 of the first compartment. In this embodiment, the female portion 64 is slidably attached to the male portion 46 and allows for the door assembly 60 to rotate open at least about 80 degrees (although it may be able to open a lessor or greater amount, for example 45 degrees or 120 degrees). The female hinge portion 64 may include a pocket portion 70 that is adapted to mate with a semi-circular projection 48 located at a terminating end of the male hinge portion 46. It is also contemplated that there are one or more projections 68 that can be used to stiffen the door or as attachment points for items located into the first compartment 40 (e.g., tubes, dispensers, lights, valves, joints, and the like).

Various embodiments are disclosed herein. It is within the scope of this disclosure that the elements of the embodiments may be combined, duplicated, or separated into additional embodiments. Also, any element disclosed herein may be eliminated from any of the assemblies disclosed herein, duplicated, and/or combined with other elements.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1. An arch support structure for a car wash system comprising:
a plurality of members, the members including:
two opposing vertical members, each including a top portion and a bottom portion; and
a horizontal member disposed between and attached to the top portion of the two opposing vertical members;
wherein one or more of the plurality of members comprise:
a housing profile that creates a first compartment and a second compartment;
a hinged door assembly slidably attached to a first edge of the first compartment; and
a removable outer wall attached to opposing walls of the second compartment.

2. The arch support structure of claim 1, wherein the hinged door assembly comprises a male hinge portion integral to the first edge and a female hinge portion integral to a door profile, said male hinge portion slidably disposed within the female hinge portion and adapted to allow at least 80 degrees of rotation between each respective hinge portion.

3. The arch support structure of claim 2, wherein the door profile mates to a ledge portion disposed at and created by a second edge of the first compartment.

4. The arch support structure of claim 1, wherein each of the opposing walls of the second compartment includes a channel portion for receiving the removable outer wall portion therein.

5. The arch support structure of claim 4, wherein the removable outer wall includes a plurality of protruding tabs adapted to compressively fit within the channel portion.

6. The arch support structure of claim 2, wherein the removable outer wall is a translucent or transparent wall.

7. The arch support structure of claim 1, wherein the one or more of the members is comprised of an aluminum extrusion.

8. The arch support structure of claim 1, wherein the one or more of the members is comprised of a polymeric pultrusion.

9. The arch support structure of claim 1, including two opposing angled members, each secured to one of the two opposing vertical members at the top portion and the one horizontal member which is disposed therebetween.

10. The arch support structure of claim 9, wherein the bottom portion of the vertical wall member is attached to an anchor member.

11. An arch support structure for a car wash system comprising:
two opposing vertical members, each including a top and a bottom portion;
two opposing angled members, each secured to one of the two opposing vertical members at the top portion; and
one horizontal member disposed between and attached to the two opposing angled members;
wherein one or more of the members comprise:
a housing profile that creates a first compartment and a second compartment;
a hinged door assembly slidably attached to a first edge of the first compartment and a removable outer wall attached to opposing walls of the second compartment, the opposing walls including a channel portion and further wherein the hinged door assembly comprises a male hinge portion integral to the first edge and a female hinge portion integral to a door profile, said male hinge portion slidably disposed within the female hinge portion and adapted to allow at least 80 degrees of rotation between each respective hinge portion and wherein the bottom portion of the vertical wall member is attached to an anchor member.

12. The arch support of claim 11, wherein the first and second compartment are substantially parallel to one another.

13. The arch support of claim 12, wherein the first and second compartment are substantially co-extensive with one another.

14. The arch support of claim 12, wherein the first and second compartment share a common wall.

15. The arch support of claim 1, wherein the first and second compartment are substantially parallel to one another.

16. The arch support of claim 15, wherein the first and second compartment are substantially co-extensive with one another.

17. The arch support of claim 1, wherein the first and second compartment share a common wall.

18. The arch support of claim 1, wherein the first and second compartments are substantially rectangular in shape.

19. The arch support of claim 1, wherein the first and second compartments are integrally formed.

20. The arch support of claim 11, wherein the first and second compartments are integrally formed.
